(19) United States
(12) Patent Application Publication
(10) Pub. No.: US 2020/0169094 A1
(43) Pub. Date: May 28, 2020

(54) CHARGING DEVICE AND OPERATING METHOD THEREOF

(71) Applicant: MERRY ELECTRONICS (SHENZHEN) CO., LTD., GUANGDONG (CN)

(72) Inventor: Hung-Yuan LI, Taichung (TW)

(21) Appl. No.: 16/362,720

(22) Filed: Mar. 25, 2019

(30) Foreign Application Priority Data
Nov. 22, 2018 (TW) 107141733

(51) Int. Cl. H02J 7/00

(52) U.S. Cl. CPC H02J 7/007; H02J 7/0045

(57) ABSTRACT

A charging device includes a battery charger, a first rechargeable battery, a first connector, a boosting circuit, a switching circuit and a first controller. The first rechargeable battery is electrically connected to the battery charger, the first connector is adapted for connecting the electronic device, and the electronic device includes a second rechargeable battery. The first controller is electrically connected to the switching circuit, and the first controller determines whether a difference by subtracting a voltage of the second rechargeable battery from a voltage of the first rechargeable battery is higher than a predetermined potential difference. When the difference is higher than the predetermined potential difference, the first controller controls the switching circuit to electrically connect the first rechargeable battery with the first connector, so that the first rechargeable battery and the first connector are electrically isolated from the boosting circuit.

### RELATED APPLICATIONS

This application claims priority to Taiwan Application Serial Number 107141733, filed Nov. 22, 2018, which is herein incorporated by reference.

### BACKGROUND

### Field of Invention

The present invention relates to devices and methods, and more particularly, a charging device and an operating method thereof.

### Description of Related Art

A rechargeable battery is a type of electrochemical battery which can be charged, discharged into a load, and recharged many times. A battery charger is a device used to put energy into a rechargeable battery by forcing an electric current through it.

However, the conversion efficiency of the booster circuit in the conventional charging device is not 100% (e.g., about 80%), and therefore a portion of the electricity is wasted. In view of the foregoing, there is an urgent need in the related field to reduce losses effectively.

### SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

According to embodiments of the present disclosure, the present disclosure provides a charging device and an operating method thereof, to solve or circumvent aforesaid problems and disadvantages in the related art.

An embodiment of the present disclosure is related to a charging device including a battery charger, a first rechargeable battery, a first connector, a boosting circuit, a switching circuit and a first controller. The first rechargeable battery is electrically connected to the battery charger. The first connector is configured to connect the electronic device, and the electronic device comprising a second rechargeable battery. The boosting circuit disposed between the first rechargeable battery and the first connector. The first controller is electrically connected to the switching circuit. The first controller is configured to determine whether a difference by subtracting a voltage of the second rechargeable battery from a voltage of the first rechargeable battery is higher than a predetermined potential difference, and when determining that the difference by subtracting the voltage of the second rechargeable battery from the voltage of the first rechargeable battery is higher than the predetermined potential difference, the first controller controls the switching circuit to electrically connect the first rechargeable battery with the first connector, so that the first rechargeable battery and the first connector are electrically isolated from the boosting circuit.

In one embodiment, when determining that the difference by subtracting the voltage of the second rechargeable battery from the voltage of the first rechargeable battery is not higher than the predetermined potential difference, the first controller controls the switching circuit to electrically connect the boosting circuit with the first rechargeable battery and the first connector.

In one embodiment, the switching circuit comprises a first switch and a second switch. The first switch is disposed between the first rechargeable battery and the boosting circuit. The second switch is disposed between the boosting circuit and the first connector.

In one embodiment, the first switch has a first terminal, a second terminal and a third terminal, the first terminal is electrically connected to the first rechargeable battery, the second terminal is electrically connected to the boosting circuit, the second switch has a fifth terminal, a sixth terminal and a seventh terminal, the fifth terminal is electrically connected to the boosting circuit, the sixth terminal is electrically connected to the third terminal, and the seventh terminal is electrically connected to the first connector. When determining that the difference by subtracting the voltage of the second rechargeable battery from the voltage of the first rechargeable battery is higher than the predetermined potential difference, the first controller controls the first terminal of the first switch to electrically connect the third terminal and controls the seventh terminal of the second switch to electrically connect the sixth terminal, so that the first terminal is electrically isolated from the second terminal, and the fifth terminal is electrically isolated from the seventh terminal. When determining that the difference by subtracting the voltage of the second rechargeable battery from the voltage of the first rechargeable battery is not higher than the predetermined potential difference, the first controller controls the first terminal of the first switch to electrically connect the second terminal and controls the seventh terminal of the second switch to electrically connect the fifth terminal, so that the first terminal is electrically isolated from the third terminal, and the sixth terminal is electrically isolated from the seventh terminal.

In one embodiment, the electronic device further comprises a second connector a charging circuit and a second controller. The second connector configured to connect the first connector. The charging circuit is electrically connected to the second connector and the second rechargeable battery. The second controller is configured to transmit information of the voltage of the second rechargeable battery to the first controller through the second connector.

In one embodiment, the predetermined potential difference is related to a charging conversion efficiency of the charging circuit.

Another embodiment of the present disclosure is related to an operating method of a charging device, the charging device includes a battery charger, a first rechargeable battery, a first connector and a boosting circuit, the first rechargeable battery electrically connected to the battery charger, the first connector configured to connect the electronic device, and the electronic device comprising a second rechargeable battery, and the operating method includes steps of: determining whether a difference by subtracting a voltage of the second rechargeable battery from a voltage of the first rechargeable battery is higher than a predetermined potential difference; and when determining that the difference by subtracting the voltage of the second rechargeable battery from the voltage of the first rechargeable battery is higher than the predetermined potential difference, electrically connecting the first rechargeable battery with the first connector, and electrically isolating the first rechargeable battery and the first connector from the boosting circuit.

In one embodiment, the operating method further includes steps of: when determining that the difference by subtracting the voltage of the second rechargeable battery from the voltage of the first rechargeable battery is not higher than the predetermined potential difference, electrically connecting the boosting circuit with the first rechargeable battery and the first connector.

In one embodiment, the switching circuit includes a first switch and a second switch, the first switch has a first terminal, a second terminal and a third terminal, the first terminal is electrically connected to the first rechargeable battery, the second terminal is electrically connected to the boosting circuit, the second switch has a fifth terminal, a sixth terminal and a seventh terminal, the fifth terminal is electrically connected to the boosting circuit, the sixth terminal is electrically connected to the third terminal, the seventh terminal is electrically connected to the first connector, and the operating method further includes steps of: when determining that the difference by subtracting the voltage of the second rechargeable battery from the voltage of the first rechargeable battery is higher than the predetermined potential difference, controlling the first terminal of the first switch to electrically connect the third terminal and controlling the seventh terminal of the switch to electrically connect the sixth terminal, so that the first terminal is electrically isolated from the second terminal, and the fifth terminal is electrically isolated from the seventh terminal; and when determining that the difference by subtracting the voltage of the second rechargeable battery from the voltage of the first rechargeable battery is not higher than the predetermined potential difference, controlling the first terminal of the first switch to electrically connect the second terminal and controlling the seventh terminal of the switch to electrically connect the fifth terminal, so that the first terminal is electrically isolated from the third terminal, and the sixth terminal is electrically isolated from the seventh terminal.

In one embodiment, the electronic device further includes a second connector and a charging circuit, the second connector configured to connect the first connector, the charging circuit electrically connected to the second connector and the second rechargeable battery, and the operating method further includes steps of: receiving information of the voltage of the second rechargeable battery from the electronic device through the first connector.

In one embodiment, the predetermined potential difference is related to a charging conversion efficiency of the charging circuit.

In view of the above, according to the present disclosure, when the difference by subtracting the voltage of the second rechargeable battery from the voltage of the first rechargeable battery is higher than the predetermined potential difference, the charging path does not need to pass through the boosting circuit, so as to reduce the loss without, thereby improving the charging efficiency of the charging device and increasing the use time of the electronic device.

Many of the attendant features will be more readily appreciated, as the same becomes better understood by reference to the following detailed description considered in connection with the accompanying drawings.

### BRIEF DESCRIPTION OF THE DRAWINGS

The invention can be more fully understood by reading the following detailed description of the embodiment, with reference made to the accompanying drawings as follows:

FIG. 1 is a block diagram illustrating a charging device in a first switching state according to some embodiments of the present disclosure;

FIG. 2 is a block diagram illustrating the charging device in a second switching state according to some embodiments of the present disclosure; and

FIG. 3 a flow chart illustrating an operating method of the charging device according to some embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

As used herein, “around”, “about”, “substantially” or “approximately” shall generally mean within 20 percent, preferably within 10 percent, and more preferably within 5 percent of a given value or range. Numerical quantities given herein are approximate, meaning that the term “around”, “about”, “substantially” or “approximately” can be inferred if not expressly stated.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

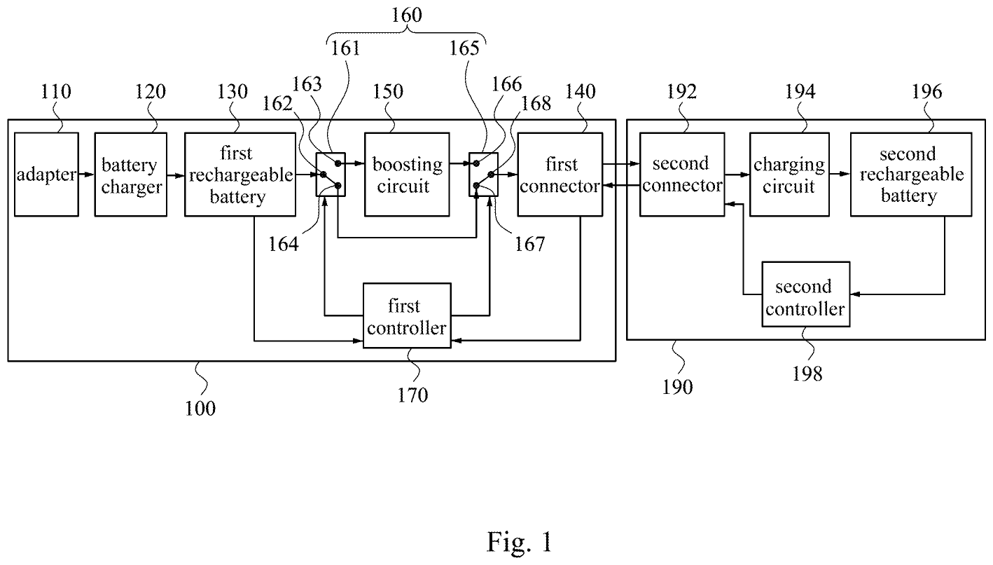

FIG. 1 is a block diagram illustrating a charging device 100 in a first switching state according to some embodiments of the present disclosure. As shown in FIG. 1, the charging device 100 can be connected to an electronic device 190 (e.g., a headset or other electronic product). In use, the charging device 100 can charge the electronic device 190.

In FIG. 1, the charging device 100 includes an adapter 110 (e.g., an USB connector), a battery charger 120, a first rechargeable battery 130, a first connector 140, a boosting circuit 150, a switching circuit 160 and a first controller 170 (e.g., a microcontroller). In structure, the first rechargeable battery 130 is electrically connected to the battery charger 120, the boosting circuit 150 is disposed between the first rechargeable battery 130 and the first connector 140, and the first controller 170 is electrically connected to the first rechargeable battery 130 and the switching circuit 160. In use, the adapter 110 can be connected to an external power supply device (e.g., a power converter, a computer, etc.), and the first connector 140 is configured to connect the electronic device 190.

In FIG. 1, the electronic device 190 includes a second connector 192, a charging circuit 194, a second rechargeable battery 196, and a second controller 198 (e.g., a microcontroller). In structure, the charging circuit 194 is electrically connected to the second connector 192 and the second rechargeable battery 196, and the second controller 198 is electrically connected to the second rechargeable battery 196 and the second connector 192. In use, the second connector 192 is configured to connect the first connector 140, and the second controller 198 transmits information of the voltage of the second rechargeable battery 196 to the first controller 170 through the second connector 192.

The first controller 170 is configured to determine whether a difference by subtracting a voltage of the second rechargeable battery 196 from a voltage of the first rechargeable battery 130 is higher than a predetermined potential difference. In one embodiment, the predetermined potential difference is related to a charging conversion efficiency of the charging circuit 194. For example, a voltage drop of the charging circuit 194 is 0.25V; the predetermined potential difference can be a value of about 0.25V or slightly greater than about 0.25V. When the difference by subtracting the voltage of the second rechargeable battery 196 from the voltage of the first rechargeable battery 130 is higher than the predetermined potential difference, it means that the voltage of the first rechargeable battery 130 can overcome the voltage drop of the charging circuit 194 and thus can charge the second rechargeable battery 196 without the boosting circuit 150. Therefore, the first controller 170 controls the switching circuit 160 to electrically connect the first rechargeable battery 130 with the first connector 140, so that the first rechargeable battery 130 and the first connector 140 are electrically isolated from the boosting circuit 150 (i.e., the first switching state). Since the charging conversion efficiency of the booster circuit 150 is not 100% (e.g., about 80%), if the charging path does not pass through the boosting circuit 150, the loss can be effectively reduced, thereby improving the charging efficiency of the charging device 100.

For a more complete understanding of the switching circuit 160, referring FIGS. 1, the switching circuit 160 includes a first switch 161 (e.g., a switch circuit) and a second switch 165 (e.g., a switch circuit). In structure, the first switch 161 is disposed between the first rechargeable battery 130 and the boosting circuit 150, and the second switch 165 is disposed between the boosting circuit 150 and the first connector 140.

In FIG. 1, the first switch 161 has a first terminal 162, a second terminal 163 and a third terminal 164, the first terminal 162 is electrically connected to the first rechargeable battery 130, and the second terminal 163 is electrically connected to the boosting circuit 150. The second switch 165 has a fifth terminal 166, a sixth terminal 167 and a seventh terminal 168, the fifth terminal 166 is electrically connected to the boosting circuit, 150 the sixth terminal 167 is electrically connected to the third terminal 164, and the seventh terminal 168 is electrically connected to the first connector 140.

When determining that the difference by subtracting the voltage of the second rechargeable battery 169 from the voltage of the first rechargeable battery 130 is higher than the predetermined potential difference, the first controller 170 controls the first terminal 162 of the first switch 161 to electrically connect the third terminal 164 and controls the seventh terminal 168 of the second switch 165 to electrically connect the sixth terminal 167 (i.e., the first switching state), so that the first terminal 162 is electrically isolated from the second terminal 163, and the fifth terminal 166 is electrically isolated from the seventh terminal 168. Thus, the first rechargeable battery 130 and the first connector 140 are electrically isolated from the boosting circuit 150.

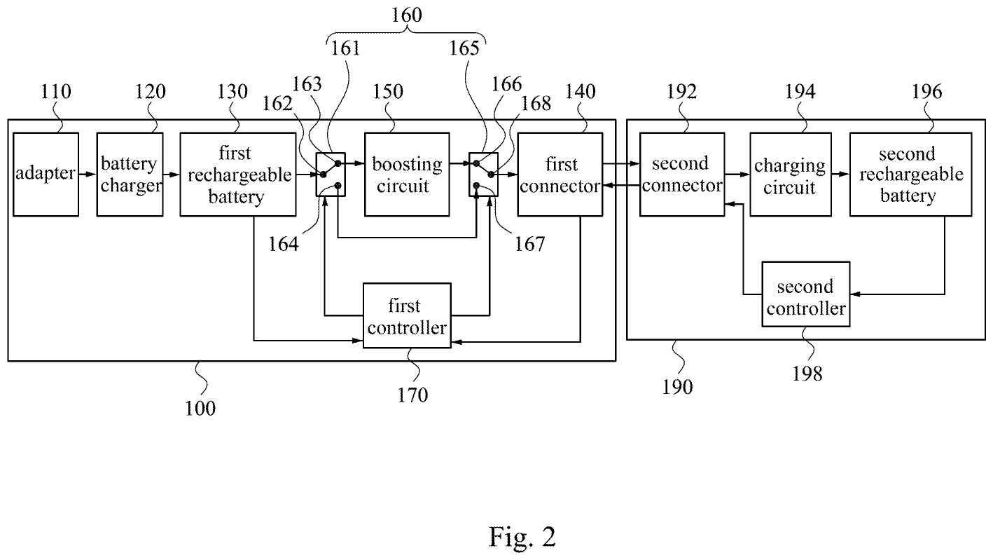

FIG. 2 is a block diagram illustrating the charging device 100 in a second switching state according to some embodiments of the present disclosure. It should be noted that the hardware structure of the charging device 100 in FIG. 2 and FIG. 1 is the same, and thus the description will not be repeated herein.

In FIG. 2, when the difference by subtracting the voltage of the second rechargeable battery 196 from the voltage of the first rechargeable battery 130 is not higher than the predetermined potential difference, it means that the voltage of the first rechargeable battery 130 cannot overcome the voltage drop of the charging circuit 194 and thus cannot charge the second rechargeable battery 196. Therefore, the boosting circuit 150 is needed to increase the voltage. For example, the boosting circuit 150 can increase the voltage to approximately 5V. Accordingly, the first controller 170 controls the switching circuit 160 to electrically connect the boosting circuit 150 with the first rechargeable battery 130 and the first connector 140 (i.e., the second switching state). After the boosting circuit 150 increases the voltage, an output voltage from the charging device 100 can overcome the voltage drop of the charging circuit 194 and thus can charge the second rechargeable battery 196.

Specifically, when the difference by subtracting the voltage of the second rechargeable battery 196 from the voltage of the first rechargeable battery 130 is not higher than the predetermined potential difference, the first controller 170 controls the first terminal 162 of the first switch 161 to electrically connect the second terminal 163 and controls the seventh terminal 168 of the second switch 165 to electrically connect the fifth terminal 166 (i.e., the second switching state), so that the first terminal 162 is electrically isolated from the third terminal 164, and the sixth terminal 167 is electrically isolated from the seventh terminal 168. Thus, the boosting circuit 150 is electrically connected with the first rechargeable battery 130 and the first connector 140.

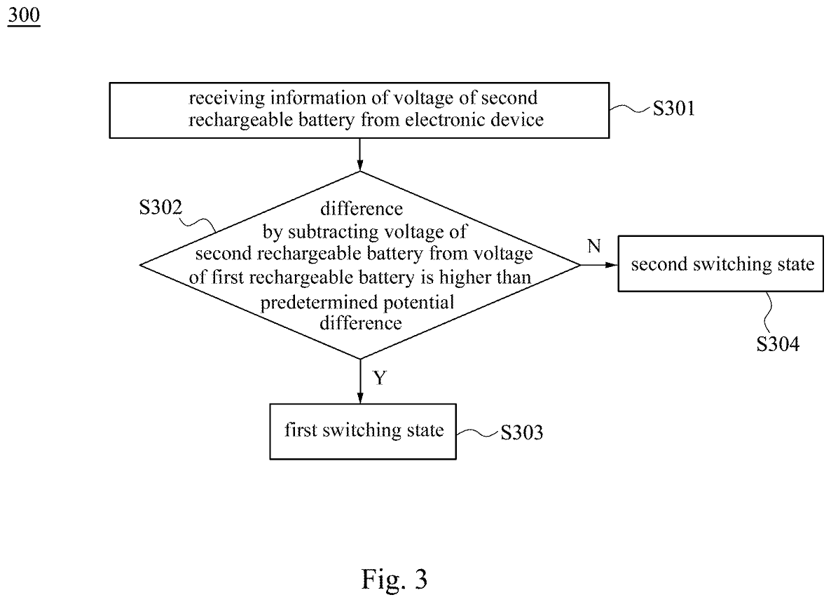

For a more complete understanding of operating the charging device 100, refer FIGS. 1-3. FIG. 3 is a flow chart illustrating an operating method 300 of the charging device 100 according to some embodiments of the present disclosure. As shown in FIG. 3, the operating method 300 includes operations S301, S302, S303 and S304. However, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently.

In operation S301, information of the voltage of the second rechargeable battery 196 is received from the electronic device 190 through the first connector 140.

In operation S302, it is determined whether a difference by subtracting a voltage of the second rechargeable battery 196 from a voltage of the first rechargeable battery 130 is higher than a predetermined potential difference. In one embodiment, the predetermined potential difference is related to a charging conversion efficiency of the charging circuit 194. For example, a voltage drop of the charging circuit 194 is 0.25V; the predetermined potential difference can be a value of about 0.25V or slightly greater than about 0.25V.

When the difference by subtracting the voltage of the second rechargeable battery 196 from the voltage of the first rechargeable battery 130 is higher than the predetermined potential difference, in operation S303, the first switching state is performed, in which the first rechargeable battery 130 is electrically connected with the first connector 140, and the first rechargeable battery 130 and the first connector 140 are electrically isolated from the boosting circuit 150. Since the charging conversion efficiency of the booster circuit 150 is not 100% (e.g., about 80%), if the charging path does not pass through the boosting circuit 150, the loss can be effectively reduced, thereby improving the charging efficiency of the charging device 100.

Specifically, when the difference by subtracting the voltage of the second rechargeable battery 196 from the voltage of the first rechargeable battery 130 is higher than the predetermined potential difference, in operation S303, the first terminal 162 of the first switch 161 is controlled to be electrically connected with the third terminal 164, and the seventh terminal 168 of the second switch 165 to is controlled to be electrically connected with the sixth terminal 167, so that the first terminal 162 is electrically isolated from the second terminal 163, and the fifth terminal 166 is electrically isolated from the seventh terminal 168. Thus, the first rechargeable battery 130 and the first connector 140 are electrically isolated from the boosting circuit 150.

On the contrary, when the difference by subtracting the voltage of the second rechargeable battery 196 from the voltage of the first rechargeable battery 130 is not higher than the predetermined potential difference, in operation S304, the second switching state is performed, in which the boosting circuit 150 is electrically connected with the first rechargeable battery 130 and the first connector 140. After the boosting circuit 150 increases the voltage, an output voltage from the charging device 100 can overcome the voltage drop of the charging circuit 194 and thus can charge the second rechargeable battery 196.

Specifically, when the difference by subtracting the voltage of the second rechargeable battery 196 from the voltage of the first rechargeable battery 130 is not higher than the predetermined potential difference, in operation S304, the first terminal 162 of the first switch 161 is controlled to be electrically connected with the second terminal 163, and the seventh terminal 168 of the second switch 165 is controlled to be electrically connected with the fifth terminal 166, so that the first terminal 162 is electrically isolated from the third terminal 164, and the sixth terminal 167 is electrically isolated from the seventh terminal 168. Thus, the boosting circuit 150 is electrically connected with the first rechargeable battery 130 and the first connector 140.

In view of the above, according to the present disclosure, when the difference by subtracting the voltage of the second rechargeable battery 196 from the voltage of the first rechargeable battery 130 is higher than the predetermined potential difference, the charging path does not need to pass through the boosting circuit 150, so as to reduce the loss without, thereby improving the charging efficiency of the charging device 100 and increasing the use time of the electronic device 190.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A charging device, comprising:
a battery charger;
a first rechargeable battery electrically connected to the battery charger;
a first connector configured to connect the electronic device, and the electronic device comprising a second rechargeable battery;
a boosting circuit disposed between the first rechargeable battery and the first connector;
a switching circuit; and
a first controller electrically connected to the switching circuit, and the first controller configured to determine whether a difference by subtracting a voltage of the second rechargeable battery from a voltage of the first rechargeable battery is higher than a predetermined potential difference, and when determining that the difference by subtracting the voltage of the second rechargeable battery from the voltage of the first rechargeable battery is higher than the predetermined potential difference, the first controller controls the switching circuit to electrically connect the first rechargeable battery with the first connector, so that the first rechargeable battery and the first connector are electrically isolated from the boosting circuit.

2. The charging device of claim 1, wherein when determining that the difference by subtracting the voltage of the second rechargeable battery from the voltage of the first rechargeable battery is not higher than the predetermined potential difference, the first controller controls the switching circuit to electrically connect the boosting circuit with the first rechargeable battery and the first connector.

3. The charging device of claim 1, wherein the switching circuit comprises:
a first switch disposed between the first rechargeable battery and the boosting circuit; and
a second switch disposed between the boosting circuit and the first connector.

4. The charging device of claim 1, wherein the first switch has a first terminal, a second terminal and a third terminal, the first terminal is electrically connected to the first rechargeable battery, the second terminal is electrically connected to the boosting circuit, the second switch has a fifth terminal, a sixth terminal and a seventh terminal, the fifth terminal is electrically connected to the boosting circuit, the sixth terminal is electrically connected to the third terminal, and the seventh terminal is electrically connected to the first connector,
wherein when determining that the difference by subtracting the voltage of the second rechargeable battery from the voltage of the first rechargeable battery is higher than the predetermined potential difference, the first controller controls the first terminal of the first switch to electrically connect the third terminal and controls the seventh terminal of the second switch to electrically connect the sixth terminal, so that the first terminal is electrically isolated from the second terminal, and the fifth terminal is electrically isolated from the seventh terminal,
when determining that the difference by subtracting the voltage of the second rechargeable battery from the voltage of the first rechargeable battery is not higher than the predetermined potential difference, the first controller controls the first terminal of the first switch to electrically connect the second terminal and controls the seventh terminal of the second switch to electrically connect the fifth terminal, so that the first terminal is electrically isolated from the third terminal, and the sixth terminal is electrically isolated from the seventh terminal.

5. The charging device of claim 1, wherein the electronic device further comprises:
a second connector configured to connect the first connector;
a charging circuit electrically connected to the second connector and the second rechargeable battery; and
a second controller configured to transmit information of the voltage of the second rechargeable battery to the first controller through the second connector.

6. The charging device of claim 5, wherein the predetermined potential difference is related to a charging conversion efficiency of the charging circuit.

7. An operating method of a charging device, the charging device comprising a battery charger, a first rechargeable battery, a first connector and a boosting circuit, the first rechargeable battery electrically connected to the battery charger, the first connector configured to connect the electronic device, and the electronic device comprising a second rechargeable battery, and the operating method comprising:
determining whether a difference by subtracting a voltage of the second rechargeable battery from a voltage of the first rechargeable battery is higher than a predetermined potential difference; and
when determining that the difference by subtracting the voltage of the second rechargeable battery from the voltage of the first rechargeable battery is higher than the predetermined potential difference, electrically connecting the first rechargeable battery with the first connector, and electrically isolating the first rechargeable battery and the first connector from the boosting circuit.

8. The operating method of claim 7, further comprising:
when determining that the difference by subtracting the voltage of the second rechargeable battery from the voltage of the first rechargeable battery is not higher than the predetermined potential difference, electrically connecting the boosting circuit with the first rechargeable battery and the first connector.

9. The operating method of claim 7, wherein the switching circuit comprises a first switch and a second switch, the first switch has a first terminal, a second terminal and a third terminal, the first terminal is electrically connected to the first rechargeable battery, the second terminal is electrically connected to the boosting circuit, the second switch has a fifth terminal, a sixth terminal and a seventh terminal, the fifth terminal is electrically connected to the boosting circuit, the sixth terminal is electrically connected to the third terminal, the seventh terminal is electrically connected to the first connector, and the operating method further comprising:
when determining that the difference by subtracting the voltage of the second rechargeable battery from the voltage of the first rechargeable battery is higher than the predetermined potential difference, controlling the first terminal of the first switch to electrically connect the third terminal and controlling the seventh terminal of the second switch to electrically connect the sixth terminal, so that the first terminal is electrically isolated from the second terminal, and the fifth terminal is electrically isolated from the seventh terminal; and
when determining that the difference by subtracting the voltage of the second rechargeable battery from the voltage of the first rechargeable battery is not higher than the predetermined potential difference, controlling the first terminal of the first switch to electrically connect the second terminal and controlling the seventh terminal of the second switch to electrically connect the fifth terminal, so that the first terminal is electrically isolated from the third terminal, and the sixth terminal is electrically isolated from the seventh terminal.

10. The operating method of claim 7, wherein the electronic device further comprises a second connector and a charging circuit, the second connector configured to connect the first connector, the charging circuit electrically connected to the second connector and the second rechargeable battery, and the operating method further comprising:
receiving information of the voltage of the second rechargeable battery from the electronic device through the first connector.

11. The operating method of claim 10, wherein the predetermined potential difference is related to a charging conversion efficiency of the charging circuit.
